(19) United States
(12) Patent Application Publication
(10) Pub. No.: US 2026/0039896 A1
(43) Pub. Date: Feb. 5, 2026

(54) AUDIO/VIDEO TRANSMISSION DEVICE AND WIRELESS DISPLAY SYSTEM

(71) Applicant: LG ELECTRONICS INC., Seoul (KR)

(72) Inventor: Jongsun KIM, Seoul (KR)

(73) Assignee: LG ELECTRONICS INC., Seoul (KR)

(21) Appl. No.: 19/276,580

(22) Filed: Jul. 22, 2025

(30) Foreign Application Priority Data
Jul. 31, 2024 (KR) 10-2024-0102127

(51) Int. Cl. H04N 21/426; H04B 17/318

(52) U.S. Cl. CPC H04N 21/42607; H04B 17/318

(57) ABSTRACT

A wireless transmission device according to an embodiment of the present disclosure comprises a compression chip configured to compresses at least one of a video signal and an audio signal, at least one antenna configured to transmit a wireless signal compressed by the compression chip, and a processor configured to control the antenna, the processor is configured to perform an antenna auto-adjustment mode that automatically adjusts an angle of the antenna.

### CROSS-REFERENCE TO RELATED APPLICATIONS

Pursuant to 35 U.S.C. § 119(a), this application claims the benefit of earlier filing date and right of priority to Korean Patent Application No. 10-2024-0102127, filed on Jul. 31, 2024, the contents of which are all hereby incorporated by reference herein in their entireties.

### BACKGROUND OF THE INVENTION

### 1.Field of the Invention

The present disclosure relates to a wireless system for transmitting and receiving A/V data wirelessly.

### 2. Discussion of the Related Art

Digital TV services using wired or wireless communication networks are becoming common. The digital TV services may provide various services that cannot be provided by existing analog broadcasting services.

For example, in the case of IPTV (Internet Protocol Television) and smart TV services, which are types of digital TV services, interactivity is provided so that users can actively select the types of programs to watch, the viewing time, and the like. IPTV and smart TV services may provide various additional services, such as Internet search, home shopping, online games, etc., based on such interactivity.

Recently, TV services are provided through wireless systems in which an A/V transmission device transmits a compressed A/V (Audio/Video) signal to an A/V reception device via a wireless connection, and the A/V reception device restores and outputs the compressed A/V signal.

In the case of a wireless display system, RF (Radio Frequency) communication is performed between the A/V transmission device and the A/V reception device via antennas, so the arrangement position relationship between the transmitting antennas and the receiving antennas is important for wireless quality.

However, the performance of the wireless signal may deteriorate due to changes such as a change in the position of the A/V transmission device or an obstacle occurring between the A/V transmission device and the A/V reception device. In this case, there was an inconvenience in the past in that the user had to adjust the antenna directly. In addition, if the user fails to properly adjust the antenna direction, the performance of the wireless signal does not improve.

### SUMMARY OF THE INVENTION

An object of the present disclosure is to provide a wireless transmission device and a wireless display system in which the antenna direction is automatically adjusted.

The object of the present disclosure is to provide a wireless transmission device and a wireless display system that minimize user inconvenience in antenna auto-adjustment mode.

The object of the present disclosure is to provide a wireless transmission device and a wireless display system that secures the performance of a wireless signal while minimizing the operating time in antenna auto-adjustment mode.

A wireless transmission device according to an embodiment of the present disclosure comprises a compression chip configured to compresses at least one of a video signal and an audio signal, at least one antenna configured to transmit a wireless signal compressed by the compression chip, and a processor configured to control the antenna, wherein the processor is configured to perform an antenna auto-adjustment mode that automatically adjusts an angle of the antenna.

A wireless display system according to an embodiment of the present disclosure comprises a wireless transmission device and wireless reception device, wherein the wireless transmission device comprises a compression chip configured to compresses at least one of a video signal and an audio signal, at least one antenna configured to transmit a wireless signal compressed by the compression chip, and a processor configured to control the antenna, wherein the processor is configured to perform an antenna auto-adjustment mode that automatically adjusts an angle of the antenna.

The processor is configured to search for a strong electric field sector while changing the angle of the antenna by a first angle unit, and determine the angle of the antenna based on a signal strength measured while changing the angle of the antenna by a second angle unit smaller than the first angle within the searched strong electric field sector, when performing the antenna auto-adjustment mode.

The processor is configured to determine an up-down angle and a left-right angle of the antenna by searching the strong electric field sector for each of up-down direction and left-right direction and then determining direction of the antenna within the searched strong electric field sector.

The processor is configured to operate by selecting one detailed operation mode among a precision mode, a general mode, and a fast mode when performing the antenna auto-adjustment mode.

The processor is configured to determine an antenna angle by searching for a strong electric field sector while changing by a first angle unit within all antenna angle ranges, and then changing by a second angle unit smaller than the first angle within the searched strong electric field sector in the precision mode, determine the antenna angle by scanning all adjustable antenna angle ranges in the general mode, and determine the antenna angle by adjusting the antenna by a predetermined angle based on the current antenna angle in the fast mode.

The processor is configured to operate in the antenna auto-adjustment mode when a power of the wireless transmission device is switched from on to off.

The processor is configured to operate in the antenna auto-tuning mode when a change in position of the wireless transmission device is detected.

The processor is configured to control a wireless reception device so that to display a message asking whether to execute operation in the antenna auto-adjustment mode when a signal strength of the wireless signal is below a preset threshold.

The wireless transmission device may further comprise an up-down adjustment motor for adjusting an angle of the antenna in vertical direction, and a left-right adjustment motor for adjusting the angle of the antenna in left-right direction.

The wireless transmission device may further comprise a case in which the compression chip, the antenna, and the processor are accommodated inside, and a plate which is placed on an upper surface of the case, and the antenna is connected at a lower portion, and is rotatable, wherein the up-down adjustment motor adjusts an up-down angle of the antenna, and the left-right adjustment motor is installed on the lower portion of the plate and rotates the plate to adjust the left-right angle of the antenna.

According to an embodiment of the present disclosure, since the antenna direction is automatically adjusted, there is a technical advantage of minimizing user inconvenience of having to directly adjust the antenna while ensuring the performance of the wireless signal.

According to an embodiment of the present disclosure, there is an advantage of minimizing the operating time in the antenna auto-adjustment mode according to the user's convenience.

According to an embodiment of the present disclosure, there is an advantage of maximizing the performance of the wireless signal through the antenna auto-adjustment mode according to the user's convenience.

### BRIEF DESCRIPTION OF THE DRAWINGS

FIGS. 1 and 2 are drawings explaining the configuration of a display system according to an embodiment of the present disclosure.

FIG. 3 is a block diagram explaining the configuration of a remote control device according to an embodiment of the present disclosure.

FIG. 4 is a ladder diagram explaining the operation method of a wireless display system according to an embodiment of the present disclosure.

FIG. 5 is a drawing showing how the antenna direction of a conventional A/V transmission device is manually changed.

FIG. 6A shows a case where the antenna direction is facing the front. FIG. 6B is an example drawing showing a case where the antenna direction is rotated 45 degrees to the right from the front.

FIG. 7 is a drawing explaining a motor of an A/V transmission device according to an embodiment of the present disclosure.

FIG. 8 is an exemplary drawing showing how an up-down adjustment motor of the A/V transmission device according to an embodiment of the present disclosure adjusts the antenna direction in an up-down direction.

FIG. 9 is an exemplary drawing showing how a left-right adjustment motor of the A/V transmission device according to an embodiment of the present disclosure adjusts the antenna direction in a left-right direction.

FIG. 10 is a flowchart illustrating an operation method of the A/V transmission device according to an embodiment of the present disclosure.

FIG. 11 is an exemplary drawing illustrating an A/V reception device according to an embodiment of the present disclosure displaying a message asking whether to execute an operation in antenna auto-adjustment mode.

FIG. 12 describes an operation method of an A/V transmission device according to a first embodiment of the present disclosure in antenna auto-adjustment mode.

FIG. 13A shows the operation of searching for a horizontal strong electric field sector. FIG. 13B shows the operation of determining a horizontal antenna angle within the strong electric field sector. FIG. 13C shows the operation of searching for a vertical strong electric field sector. FIG. 13D shows the operation of determining a vertical antenna angle within the strong electric field sector.

FIG. 14 is an exemplary drawing illustrating an A/V transmission device according to a second embodiment of the present disclosure displaying a menu for selecting various detailed operation modes in antenna auto-adjustment mode.

FIG. 15 is a flowchart illustrating a method of adjusting an antenna when a wireless transmission device according to an embodiment of the present disclosure receives a power-on command.

FIG. 16 is a diagram for explaining a method for operating a wireless transmission device in an antenna beam adjustment mode according to an embodiment of the present disclosure.

FIG. 17 is a flowchart illustrating a method for adjusting an antenna when a wireless transmission device according to an embodiment of the present disclosure receives a power-off command.

### DETAILED DESCRIPTION OF THE PREFERRED EMBODIMENTS

The audio/video (hereinafter, A/V) transmission device according to an embodiment of the present disclosure is an intelligent device that adds a computer support function to a broadcast reception function, for example, and while remaining faithful to the broadcast reception function, it can have an Internet function, etc., and can have a more convenient interface such as a manual input device, a touch screen, or a space remote control.

In addition, it can perform functions such as email, web browsing, banking, or games by connecting to the Internet and a computer with the support of a wired or wireless Internet function. A standardized general-purpose OS can be used for these various functions.

Therefore, the A/V transmission device described in the present disclosure can perform various user-friendly functions since various applications can be freely added or deleted on, for example, a general-purpose OS kernel.

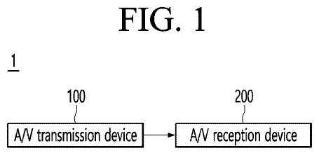

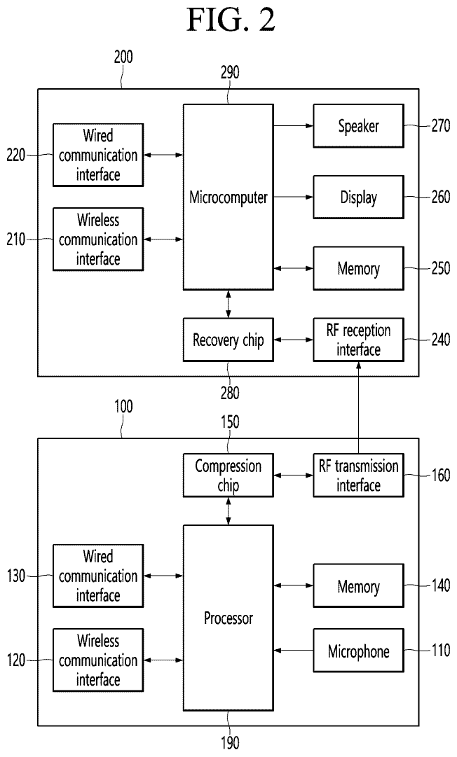

FIGS. 1 and 2 are diagrams explaining the configuration of a wireless display system according to an embodiment of the present disclosure.

Referring to FIG. 1, a wireless display system 1 according to an embodiment of the present disclosure includes an A/V transmission device 100 and an A/V reception device 200.

The wireless display system 1 may be a system in which the A/V transmission device 100 wirelessly transmits A/V data to the A/V reception device 200, and the A/V reception device 200 outputs A/V data.

The A/V transmission device 100 may be a device capable of encoding video and audio and wirelessly transmitting encoded content video and audio.

The A/V transmission device 100 may be a set-top box.

The A/V transmission device 100 may be connected to an external device, such as a set-top box or a USB memory. The A/V transmission device 100 may transmit a video signal or audio signal received from the connected external device to the A/V reception device 200.

The A/V reception device 200 may be a display device that wirelessly receives encoded video and audio and performs decoding of the received video and audio.

The A/V transmission device 100 and the A/V reception device 200 may configure a video wall display system.

In a video wall, having a display with a thin bezel plays an important role in visualizing content images. In order to have a thin bezel of the display, it is efficient to have only components that can play a minimum role, and to perform circuits or components for main functions in a separate device.

The A/V transmission device 100 may determine the type of content image input from the outside, and determine a compression ratio of the content image based on the determined type. The compression ratio of the content image may be defined as a ratio of the size of the image data before encoding and the size of the image data after encoding.

The type of content image can include still image type, general video type, and game video type.

The A/V transmission device 100 can compress a content image according to a determined compression ratio and transmit the compressed content image wirelessly to the A/V reception device 200.

The A/V reception device 200 can restore the compressed content image received from the A/V transmission device 100 and display the restored content image on a display.

FIG. 2 is a block diagram illustrating a detailed configuration of the A/V transmission device 100 and the A/V reception device 200.

Referring to FIG. 2, the A/V transmission device 100 can include a microphone 110, a wireless communication interface 120, a wired communication interface 130, a memory 140, a compression chip 150, an RF transmission interface 160, and a processor 190.

The microphone 110 can receive an audio signal and transmit it to the processor 190.

The microphone 110 can receive a voice spoken by a user.

The wireless communication interface 120 can include one or more of a Wi-Fi module and a Bluetooth module.

The Wi-Fi module can perform wireless communication with an external device or the A/V reception device 200 through the Wi-Fi standard.

The Bluetooth module can perform wireless communication through the Bluetooth Low Energy (BLE) standard.

The Bluetooth module can perform wireless communication with an external device such as a remote control device or the A/V reception device 200 through the Bluetooth Low Energy (BLE) standard.

The wireless communication interface 120 may also be equipped with a tuner that receives a broadcast signal.

The wired communication interface 130 may be an interface for wired connection with an external device. The wired communication interface 130 may include multiple HDMI (High Definition Multimedia Interface) terminals or USB (Universal Serial Bus) ports.

The wired communication interface 130 may receive a video signal or an audio signal from an external device.

The memory 140 may store a program for signal processing and control, and may store a processed video, audio, or data signal.

The memory 140 may perform a function for temporary storage of a video, audio, or data signal input from an external source, and may store information about a predetermined image through a channel memory function.

The compression chip 150 may compress a video signal or an audio signal input from an external source, and transmit the compressed signal to the RF transmission interface 160

The compression chip 150 may be equipped with an encoder for compressing a video signal or an audio signal.

The RF transmission interface 160 can transmit an A/V signal to the RF (Radio Frequency) reception interface 240 of the A/V reception device 200 via RF communication.

The RF transmission interface 160 may include one or more antennas.

The RF transmission interface 160 may transmit a compressed A/V signal in digital form to the RF reception interface 240.

The RF transmission interface 160 may transmit the A/V signal to the RF reception interface 240 through one or more channels.

The processor 190 may control the overall operation of the A/V transmission device 100. The processor 190 may be referred to as a Main System on Chip (Main SoC).

The processor 190 may also include the compression chip 150.

The A/V reception device 200 may include a wireless communication interface 210, a wired communication interface 220, an RF reception interface 240, a memory 250, a display 260, a speaker 270, a recovery chip 280, and a microcomputer 290.

The wireless communication interface 210 may include a Wi-Fi module, a Bluetooth module, and an IR module.

The Wi-Fi module may perform wireless communication through the Wi-Fi standard.

The Wi-Fi module may perform wireless communication with an external device or the A/V transmission device 100 through the Wi-Fi standard.

The Bluetooth module may perform wireless communication through the Bluetooth Low Energy (BLE) standard.

The Bluetooth module may perform wireless communication with an external device such as a remote control device or the A/V transmission device 100 through the Bluetooth Low Energy standard.

The IR module may receive a signal from a remote control device 300 described below through IR (Infrared) communication.

The wired communication interface 220 may be an interface for wired connection with an external device. The wired communication interface 220 may include multiple HDMI (High Definition Multimedia Interface) terminals or USB (Universal Serial Bus) ports.

The wired communication interface 220 may receive a video signal or an audio signal from an external device.

The RF reception interface 240 may receive a compressed A/V signal from the RF transmission interface 160.

The RF reception interface 240 may include a plurality of antennas. The RF reception interface 240 may be arranged at the bottom of the display 260.

The RF reception interface 240 may include a first antenna module and a second antenna module. The first antenna module and the second antenna module may each include multiple antennas.

The RF reception interface 240 can receive a compressed A/V signal in digital form from the RF transmission interface 160 and transmit the received A/V signal to the recovery chip 280.

The memory 250 can store a program for signal processing and control and can store a signal-processed image, voice, or data signal.

The display 260 can display a video signal received from the microcomputer 290.

The display 260 can display a video signal according to the operation of a timing controller (not shown).

The recovery chip 280 can restore the compressed A/V signal received by the RF reception interface 240. For this purpose, the recovery chip 280 can include a decoder.

The microcomputer 290 can control the overall operation of the A/V reception device 200.

The microcomputer 290 can output restored video signal through the display 260 and output restored audio signal through the speaker 270.

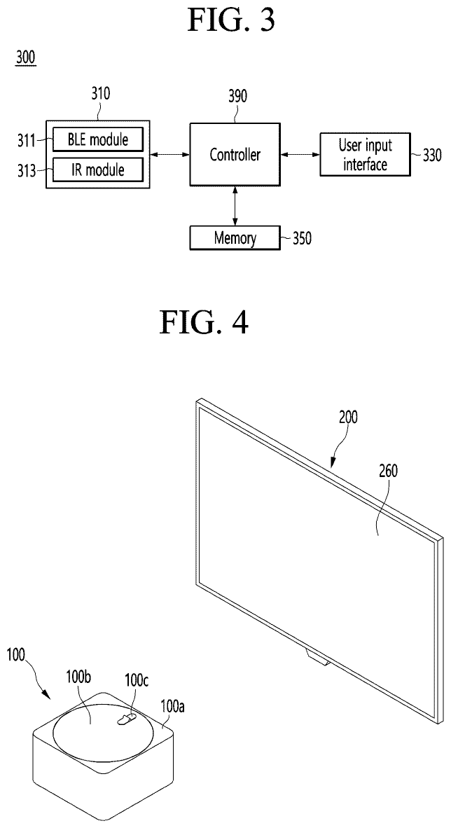

FIG. 3 is a block diagram illustrating the configuration of a remote control device according to an embodiment of the present disclosure.

Referring to FIG. 3, the remote control device 300 may include a wireless communication interface 310, a user input interface 330, a memory 350, and a controller 390.

The wireless communication interface 310 may be an interface for performing wireless communication with the A/V transmission device 100 or the A/V reception device 200.

The wireless communication interface 310 may include a Bluetooth Low Energy (BLE) module 311 and an IR (InfraRed) module 313.

The BLE module 311 can transmit a signal to the A/V transmission device 100 for controlling the operation of the A/V transmission device 100.

The BLE module 311 can transmit a signal to the A/V transmission device 100 for triggering a pairing operation of the A/V transmission device 100.

The user input interface 330 can be configured as a keypad, a button, a touch pad, or a touch screen.

The user input interface 330 can generate a control command to control the operation of the A/V transmission device 100 or the A/V reception device 200 according to a user's operation command.

If the user input interface 330 has a hard key button, the user can operate the hard key by pushing the hard key button.

The user input interface 330 may be equipped with various types of input means that can be operated by the user, such as scroll keys or jog keys.

The memory 350 can store a program for the operation of the controller 390 and can also temporarily store input/output data.

The controller 390 controls operations related to the application program and, typically, the overall operation of the remote control device 300.

FIG. 4 is an exemplary drawing showing the operation of a wireless display system according to an embodiment of the present disclosure.

The A/V transmission device 100 may refer to a wireless transmission device that transmits a wireless signal, and the A/V reception device 200 may refer to a wireless reception device that receives a wireless signal from the A/V transmission device 100.

The A/V transmission device 100 may be installed in a manner that is placed on a table, etc. The A/V transmission device 100 may be placed in an arbitrary position depending on the structure of the space or the convenience of the user. The A/V transmission device 100 may also be installed on a wall or ceiling.

The A/V reception device 200 may be installed in the form of a wall mount, etc. The A/V reception device 200 may receive a wireless signal including A/V data, etc. from the A/V transmission device 100, and perform various operations such as outputting images and audio based on the received wireless signal.

The performance of these wireless signals can vary depending on various factors such as the arrangement of the A/V transmission device 100 and the A/V reception device 200, obstacles between them, etc. In particular, the performance of the wireless signal can be severely degraded, and in this case, the antenna direction needs to be adjusted. In the past, the user was asked to directly adjust the antenna direction. For example, when the performance of the wireless signal was degraded, a guidance message was displayed on the display 260 to adjust the antenna direction.

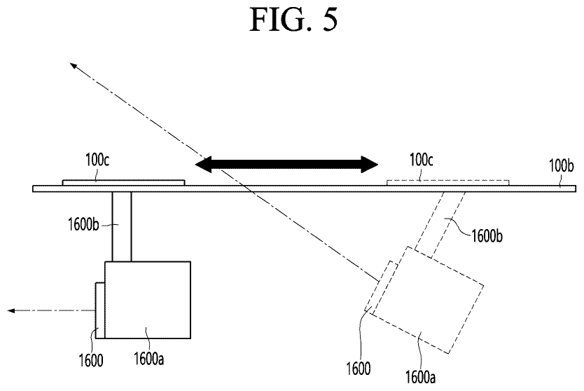

The A/V transmission device 100 may include a case 100a, a plate 100b arranged on an upper surface of the case 100a, and a handle 100c formed on an upper surface of the plate 100b. An antenna 1600 (see FIG. 5) is installed on a lower portion of the plate 100b and may be connected to the handle 100c, in particular, Accordingly, the antenna direction is also changed according to the change in the position of the handle 100c. The user manually changes the antenna direction through the handle 100c.

In this specification, the antenna direction may mean the direction in which the antenna 1600 (see FIG. 5) transmits a signal.

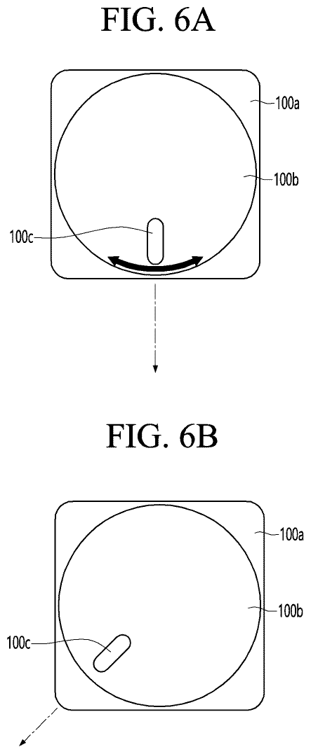

FIG. 5 and FIG. 6 are drawings showing how the antenna direction of a conventional A/V transmission device is manually changed. In particular, FIG. 5 shows how the antenna direction is changed in the up-down direction, and FIG. 6 shows how the antenna direction is changed in the left-right direction.

The antenna 1600 of the conventional A/V transmission device 100 may be installed at the bottom of the plate 100b. As a specific example, the antenna 1600 may be installed in an antenna case 1600a, and the antenna case 1600a may be connected to the handle 100c through a connecting member 1600b.

Referring to FIG. 5, the handle 100c may be a button. The handle 100c may be moved forward and backward by the user. By moving the handle 100c, the antenna 1600 can also move in the same way. The further forward the handle 100c is positioned, the more the antenna direction can face the front. As the handle 100c moves backward, the antenna 1600 can rotate so that the antenna direction faces increasingly upward. When the handle 100c is positioned at the rearmost position, the direction of the antenna 1600 can rotate upward at the maximum angle based on the front direction. In this way, the up-down direction of the antenna 1600 of the conventional A/V transmission device 100 was changed by the forward-backward movement of the handle 100c.

Referring to FIG. 6, the plate 100b may be a dial. The user may rotate the plate 100b clockwise or counterclockwise. The antenna direction may be changed to the left and right by the rotation of the plate 100b. FIG. 6A shows a case where the antenna direction is facing the front, and FIG. 6B is an example drawing showing a case where the antenna direction is rotated 45 degrees to the right from the front.

As such, in the past, the user manually changed the antenna direction by rotating the plate 100b or moving the handle 100c. Therefore, there was an inconvenience that the user had to adjust it manually. In addition, even if the user refers to the antenna adjustment guide, the user may not be able to resolve the problem of performance degradation of the wireless signal due to inexperience in antenna adjustment.

Accordingly, the present disclosure seeks to provide a wireless transmission device and a wireless display system in which the antenna is automatically adjusted.

An A/V transmission device according to an embodiment of the present disclosure may include at least one motor for automatically adjusting the antenna direction.

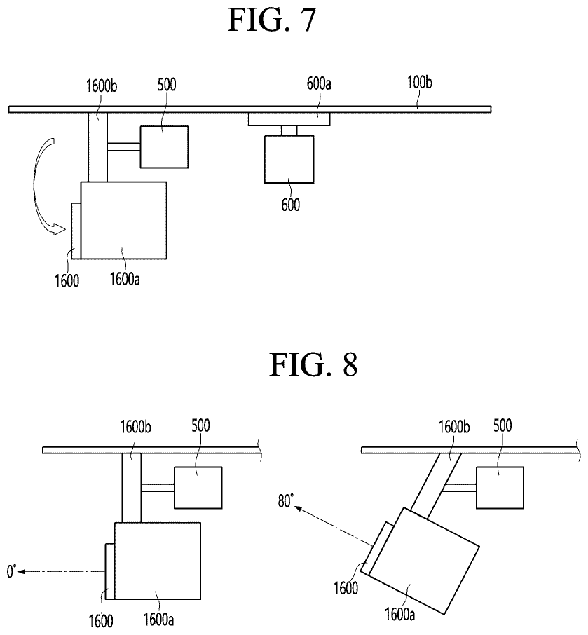

FIG. 7 is a drawing for explaining a motor of an A/V transmission device according to an embodiment of the present disclosure.

The A/V transmission device 100 according to an embodiment of the present disclosure may further include at least one motor 500 600. The motor 500 600 may adjust the antenna direction. In the example of FIG. 7, the up-down adjustment motor 500 for adjusting the antenna direction in the up-down direction and the left-right adjustment motor 600 for adjusting the antenna direction in the left-right direction are respectively provided. However, this is merely an example, and according to an embodiment, one motor may be provided to adjust the antenna direction in the up-down direction and the left-right direction, respectively. In this specification, the up-down adjustment motor 500 and the left-right adjustment motor 600 are described as adjusting the antenna direction in the up-down direction and the left-right direction, respectively.

The up-down adjustment motor 500 may be connected to the connecting member 1600b. Alternatively, the up-down adjustment motor 500 may be connected to the antenna case 1600a, unlike as illustrated in FIG. 7. The up-down adjustment motor 500 may rotate the connecting member 1600b (or the antenna case 1600a) up and down. By driving the up-down adjustment motor 500, the connecting member 1600b (or the antenna case 1600a) rotates up and down, and accordingly, the antenna direction may also be changed up and down.

The left-right adjustment motor 600 may be directly or indirectly connected to the plate 100b. In the example of FIG. 7, the left-right adjustment motor 600 is illustrated as being indirectly connected to the plate 100b via an intermediate member 600a. However, this is merely an example, and unlike the example of FIG. 7, the left-right adjustment motor 600 may be directly connected to the plate 100b. The left-right adjustment motor 600 may rotate the plate 100b clockwise or counterclockwise. By driving the left-right adjustment motor 600, the plate 100b rotates left and right, and accordingly, the antenna direction may also be changed left and right.

FIG. 8 is an exemplary drawing showing an up-down adjustment motor of an A/V transmission device according to an embodiment of the present disclosure adjusting an antenna direction in the up-down direction.

The up-down adjustment motor 500 can adjust the antenna direction in the up-down direction. By driving the up-down adjustment motor 500, the antenna direction can be adjusted between a minimum angle and a maximum angle in the up-down direction.

In the example of FIG. 8, the minimum angle may be 0°, which may be a direction parallel to the lower surface of the case 100a. The maximum angle may be an angle tilted upward by a predetermined angle based on 0°. For example, the maximum angle may be 80°, but this is only an example.

The antenna direction can be adjusted from 0° to 80° in the vertical direction. Meanwhile, the minimum angle and maximum angle described above are only examples and are not limited thereto.

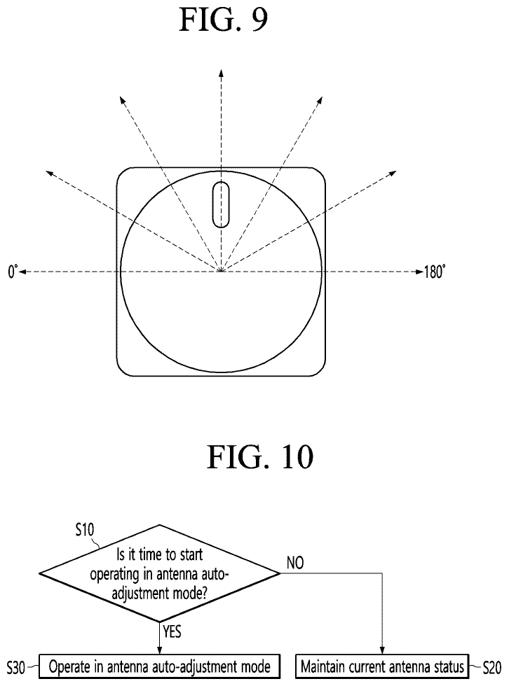

FIG. 9 is an exemplary drawing showing a left-right adjustment motor of an A/V transmission device according to an embodiment of the present disclosure adjusting the antenna direction in the left-right direction.

The left-right adjustment motor 600 can adjust the antenna direction in the left-right direction. By driving the left-right adjustment motor 600, the antenna direction can be adjusted from the minimum angle to the maximum angle in the left-right direction.

In the example of FIG. 9, the minimum angle may be 0°, which may be a direction that vertically penetrates the left side of the case 100a. The maximum angle may be 180°, which may be a direction that vertically penetrates the right side of the case 100a.

The antenna direction can be adjusted between 0° and 180° in the horizontal direction. Meanwhile, the minimum and maximum angles described above are only examples and are not limited thereto.

In this way, the operation method of a wireless transmission device and a wireless display system in which the antenna direction is automatically adjusted by the up-down adjustment motor 500 and the left-right adjustment motor 600 is described.

FIG. 10 is a flowchart illustrating an operation method of a wireless transmission device according to the first embodiment of the present disclosure.

The processor 190 can determine whether it is time to operate in an antenna auto-adjustment mode S10.

The antenna auto-adjustment mode is an operation mode in which the antenna direction is automatically adjusted by at least one of the up-down adjustment motor 500 and the left-right adjustment motor 600.

There may be various ways to determine whether it is time for processor 190 to operate in antenna auto-adjustment mode or not.

Hereinafter, various embodiments for determining whether the timing for operation in the antenna auto-adjustment mode will be described.

According to the first embodiment, the processor 190 can determine whether it is time to operate in the antenna auto-adjustment mode at preset periods. The periods can be set as a default when the A/V transmission device 100 is manufactured.

The period can also be set by user input. For example, the period can be set to 2 hours, 6 hours, 1 day, etc. The processor 190 can control the display 260 to display a period setting menu (not shown) for setting the period.

In this case, there is an advantage that the timing of operation in the antenna auto-adjustment mode is determined according to the user's convenience.

According to the second embodiment, the processor 190 can determine whether or not it is time to operate in antenna auto-adjustment mode when the power is switched from off to on. The point in time when the power is switched from off to on is the point in time when the antenna 1600 starts transmitting a wireless signal in earnest. In this respect, the processor 190 can determine the timing of operation in the antenna auto-adjustment mode when the power is switched from off to on.

In this case, since the antenna direction is automatically adjusted before the wireless signal is transmitted in earnest, there is an advantage in that the wireless signal is transmitted stably.

According to the third embodiment, the processor 190 can determine whether or not it is time to operate in antenna auto-adjustment mode when the power is switched from on to off. Since it takes some time for the antenna direction to be adjusted, it may cause inconvenience to users who want to watch videos. In this respect, there is an advantage in that user inconvenience is minimized by operating in the antenna auto-adjustment mode when the power is switched off.

According to the fourth embodiment, the processor 190 can determine whether or not it is time to operate in antenna auto-adjustment mode when changing channels. The timing of a channel change means a situation in which a user is watching a video, and thus, there is an advantage in that stable viewing of the video is enabled by operating in the antenna auto-adjustment mode at the timing of a channel change.

According to the fifth embodiment, the processor 190 can determine whether or not it is time to operate in antenna auto-adjustment mode when a change in the position of the A/V transmission device 100 is detected. The A/V transmission device 100 can include at least one of an acceleration sensor (not shown) and an angular velocity sensor (not shown), and can detect a change in the position of the A/V transmission device 100 based on sensing of such a sensor. When a change in the position of the A/V transmission device 100 is detected, the processor 190 can operate in the antenna auto-adjustment mode. If the position of the A/V transmission device 100 changes, the antenna direction is likely to change as well, so the antenna direction can be readjusted.

In this case, there is an advantage of minimizing the problem of the performance of the wireless signal being degraded despite the change in the position of the A/V transmission device 100.

According to the sixth embodiment, the processor 190 can determine whether it is time to operate in antenna auto-adjustment mode when a change in the performance of a wireless signal is detected. In particular, the processor 190 can determine the time point at which a degradation in the performance of a wireless signal is detected as the timing of operation in the antenna auto-adjustment mode. The processor 190 can calculate a SNR (Signal-to-Noise Ratio), an RSSI (Received Signal Strength Indicator), Power, etc. The processor 190 can obtain the calculated SNR (Signal-to-Noise Ratio), an RSSI (Received Signal Strength Indicator), Power, etc. as wireless performance. The processor 190 can determine whether the obtained wireless performance is less than a preset threshold. If the obtained wireless performance is less than a preset threshold, the processor 190 can determine that the wireless performance is degraded. If the wireless performance is less than a preset threshold, the processor 190 can determine the timing of operation in the antenna auto-adjustment mode.

According to one embodiment, the processor 190 can operate in antenna auto-adjustment mode immediately when the wireless performance is below the preset threshold.

According to another embodiment, the processor 190 can control the display 260 to display a message asking whether to first operate in antenna auto-adjustment mode when the wireless performance is below the preset threshold.

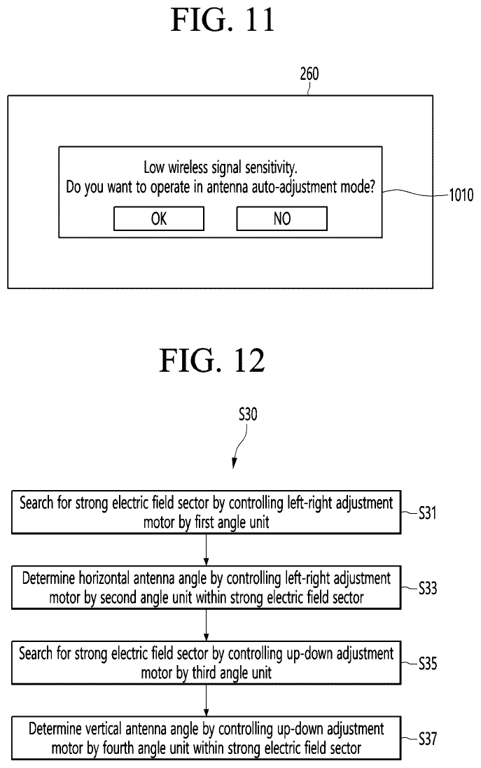

FIG. 11 is an exemplary drawing showing an A/V reception device according to an embodiment of the present disclosure displaying a message asking whether to execute an operation in antenna auto-adjustment mode.

The processor 190 may control the display 260 to display a message 1010 asking whether to execute an operation in antenna auto-adjustment mode when the wireless performance is below the preset threshold. As shown in FIG. 11, the display 260 may display the message 1010 under the control of the A/V transmission device 100. The message 1010 may include text asking whether to execute an operation in antenna auto-adjustment mode, an OK button, and a NO button.

The processor 190 can operate in the antenna auto-adjustment mode upon receiving a command to select the OK button.

As described above, the processor 190 can determine whether it is the timing for operating in the antenna auto-adjustment mode in various ways.

Again, FIG. 10 is described.

If the processor 190 is not determined to be the timing for operating in the antenna auto-adjustment mode, the processor 190 can maintain the current antenna state S20.

That is, if the processor 190 is not determined to be the timing for operating in the antenna auto-adjustment mode, the processor 190 can maintain the current antenna direction.

If the processor 190 is determined to be the timing for operating in the antenna auto-adjustment mode, the processor 190 can operate in the antenna auto-adjustment mode S30.

Next, a method for operating in the antenna auto-adjustment mode is described.

FIG. 12 describes an operation method of an A/V transmission device according to the first embodiment of the present disclosure in antenna auto-adjustment mode.

When the processor 190 starts operation in the antenna auto-adjustment mode, the processor 190 can first control the left-right adjustment motor 600 by a first angle unit to search for a strong electric field sector S31.

For example, the first angle may be 30 degrees, but this is only an example. The processor 190 can measure signal strength while moving the antenna direction in the left-right direction by the first angle. The processor 190 can search for a strong electric field sector in the horizontal direction based on the measured signal strength.

The processor 190 can control the left-right adjustment motor 600 by a second angle unit within the strong electric field sector to determine a horizontal antenna angle S33.

The second angle may be smaller than the first angle. For example, the second angle may be 10 degrees, but this is only an example.

The processor 190 may measure the signal strength while moving the antenna direction by second angle unit within the strong electric field sector. The processor 190 may determine the angle at which the signal strength is measured the highest as the horizontal antenna angle.

The processor 190 may determine the vertical antenna angle after determining the horizontal antenna angle.

The processor 190 may control the up-down adjustment motor 500 by a third angle unit to search for the strong electric field sector S35.

For example, the third angle may be 20 degrees, but this is only an example. The third angle may be the same as the first angle.

The processor 190 can measure the signal strength while moving the antenna direction in the up-down direction by a third angle. The processor 190 can search for a strong electric field sector in the vertical direction based on the measured signal strength.

The processor 190 can control the up-down adjustment motor 500 in the strong electric field sector by a fourth angle unit to determine the vertical antenna angle S37.

The fourth angle can be smaller than the third angle. For example, the fourth angle can be 10 degrees, but this is only an example. The third angle can be the same as the second angle.

The processor 190 can measure signal strength while moving the antenna direction by the fourth angle unit within the strong electric field sector. The processor 190 can determine the angle at which the signal strength is measured the highest as the vertical antenna angle.

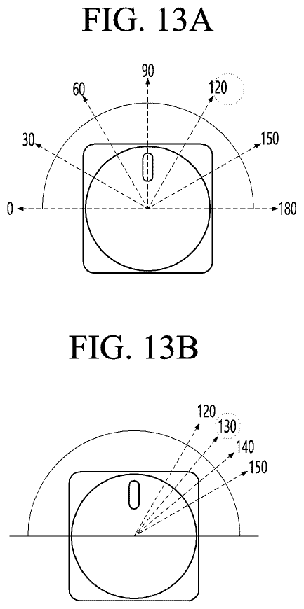

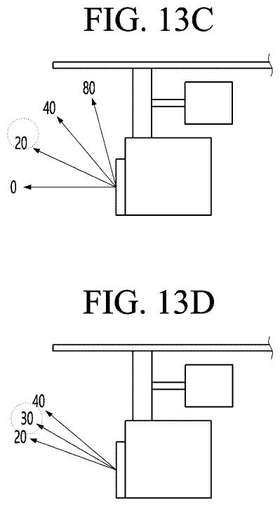

FIG. 13 is an example drawing showing the operation of the antenna auto-adjustment mode described in FIG. 12.

FIG. 13A shows the operation of searching for a horizontal strong electric field sector, and FIG. 13B shows the operation of determining a horizontal antenna angle within the strong electric field sector.

Referring to FIG. 13A, the processor 190 measured the signal strength while moving the left-right adjustment motor 600 by 30 degrees. That is, the processor 190 measured the signal strength at 0 degrees, 30 degrees, 60 degrees, 90 degrees, 120 degrees, 150 degrees, and 180 degrees, respectively. The signal strength was measured to be the highest at 120 degrees, and the second highest at 150 degrees. Accordingly, the processor 190 can obtain the strong electric field sector in the horizontal direction between 120 degrees and 150 degrees.

Referring to FIG. 13B, the processor 190 measured the signal strength while moving the left-right adjustment motor 600 by 10 degrees between 120 degrees and 150 degrees, which are strong electric field sectors. That is, the processor 190 measured the signal strength at 120 degrees, 130 degrees, 140 degrees, and 150 degrees, respectively. The signal strength was measured the highest at 130 degrees. Accordingly, the processor 190 can determine the horizontal antenna angle as 130 degrees.

FIG. 13C shows the operation of searching for a vertical strong electric field sector, and FIG. 13D shows the operation of determining a vertical antenna angle within the strong electric field sector.

Referring to FIG. 13C, the processor 190 measured the signal strength while moving the up-down adjustment motor 500 by 20 degrees. That is, the processor 190 measured the signal strength at 0 degrees, 20 degrees, 40 degrees, 60 degrees, and 80 degrees, respectively. The signal strength was measured the highest at 20 degrees, and the second highest at 40 degrees. Accordingly, the processor 190 can obtain an area between 20 degrees and 40 degrees as a strong electric field sector in the vertical direction.

Referring to FIG. 13D, the processor 190 measured the signal strength while moving the up-down adjustment motor 500 by 10 degrees between 20 degrees and 40 degrees, which are strong electric field sectors. That is, the processor 190 measured the signal strength at 20 degrees, 30 degrees, and 40 degrees, respectively. The signal strength was measured to be the highest at 30 degrees. Accordingly, the processor 190 can determine the vertical antenna angle to be 30 degrees.

As described above, according to the first embodiment of the present disclosure, there is an advantage in that the processor 190 can precisely determine the antenna angle by first searching for strong electric field sectors in each of the horizontal and vertical directions, and then secondarily determining the antenna angle within the searched strong electric field sectors.

Meanwhile, if the antenna angle is precisely determined, the performance of the wireless signal is maximized, but the time required for antenna determination may be long. Depending on the user, user want that the performance of the wireless signal may be maximized. or the time required for antenna direction determination may be shortened.

Accordingly, the A/V transmission device according to the second embodiment of the present disclosure can provide various detailed operation modes in the antenna auto-adjustment mode.

The A/V transmission device 100 can provide at least one of a precision mode. a general mode, and a fast mode as the antenna auto-adjustment mode.

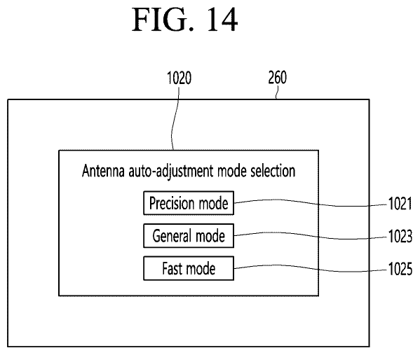

FIG. 14 is an exemplary drawing showing a menu for receiving a selection from various detailed operation modes in the antenna auto-adjustment mode according to the second embodiment of the present disclosure in the A/V transmission device.

The processor 190 can control the display 260 to display a detailed operation mode selection menu 1020 for receiving a selection of a detailed operation mode of the antenna auto-adjustment mode when starting operation in the antenna auto-adjustment mode. The detailed operation mode selection menu 1020 can include at least one of the precision mode 1021, the general mode 1023, and the fast mode 1025.

The precision mode represents an operation mode that determines the antenna angle through steps divided into first and second stages. The processor 190 can determine the antenna angle through the method described in FIG. 12 and FIG. 13.

The general mode indicates an operation mode that determines the antenna angle after scanning all adjustable antenna angle ranges. When the processor 190 operates in the general mode, the signal strength can be measured while adjusting the antenna direction by a predetermined angle unit in all antenna angle ranges. The processor 190 can determine the antenna angle as the angle at which the signal strength is measured the highest.

For example, the processor 190 can measure the signal strength while moving the antenna direction horizontally by 30 degrees, and determine the angle at which the signal strength is measured the highest as the horizontal antenna angle. The processor 190 can measure the signal strength while adjusting the antenna direction vertically by 30 degrees after adjusting the horizontal antenna direction as the determined horizontal antenna angle. The processor 190 can determine the angle at which the signal strength is measured the highest as the vertical antenna angle. That is, in this case, the antenna direction can be determined by performing only the operations described in FIG. 13A and FIG. 13C.

The fast mode refers to an operation mode that determines the antenna angle while adjusting the antenna to a predetermined angle based on the current antenna angle. The fast mode is an operation mode that does not scan the entire antenna angle range. When the processor 190 operates in the fast mode, the processor 190 can measure the signal strength after adjusting the antenna direction by a predetermined angle from the current antenna angle. If the measured signal strength is greater than or equal to a preset reference value, the processor 190 can determine the current antenna angle as the horizontal antenna angle. If the measured signal strength is less than the preset reference value, the processor 190 can adjust the antenna direction by a predetermined angle again based on the current antenna angle and then measure the signal strength. In other words, the processor 190 can repeat the operation of adjusting the antenna direction by a predetermined angle and then measuring and comparing the signal strength with the preset reference value until the measured signal strength is greater than or equal to the preset reference value.

After determining the horizontal antenna angle, the processor 190 can apply the same method to the vertical antenna angle to determine the vertical antenna angle.

In this case, there is an advantage that a certain level of performance can be secured while the antenna angle can be quickly determined since the signal performance is higher than the reference value.

Meanwhile, the wireless transmission device according to FIG. 10 adjusted the antenna after determining whether the timing of operation of the antenna auto-adjustment mode. According to another embodiment of the present disclosure, the wireless transmission device can adjust the antenna based on the compression ratio (or wireless signal sensitivity) at the time of power on/off.

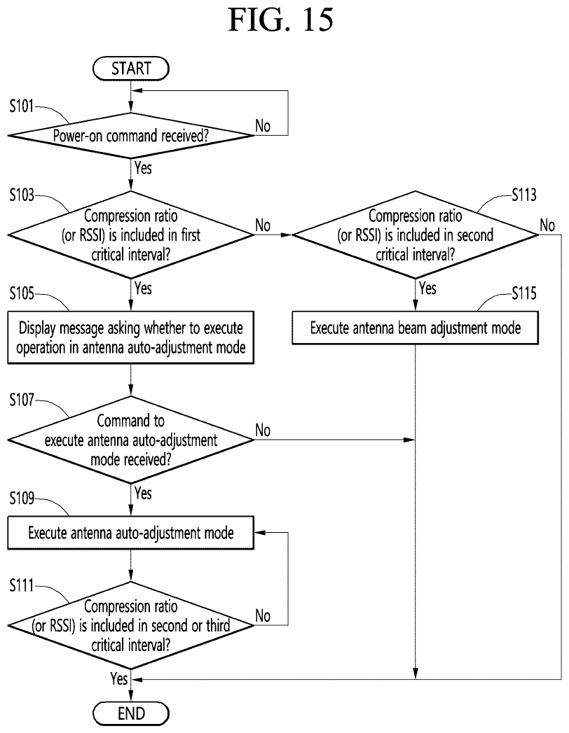

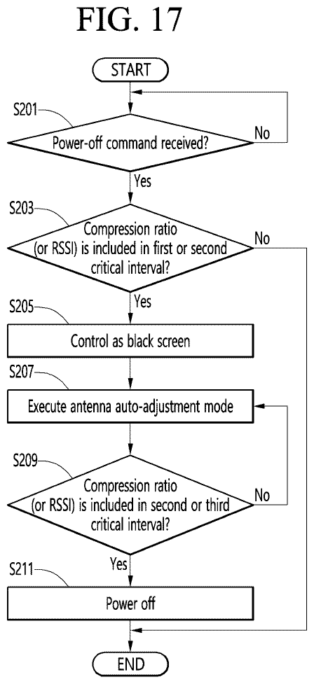

Hereinafter, the operation method of the wireless transmission device according to the second embodiment of the present disclosure will be described with reference to FIGS. 15 to 17. FIGS. 15 and 17 are flowcharts illustrating a method for the wireless transmission device according to the embodiment of the present disclosure to adjust the antenna based on the compression ratio at the time of power on/off.

FIG. 15 is a flowchart illustrating a method for the wireless transmission device according to the embodiment of the present disclosure to adjust the antenna when receiving a power-on command.

The processor 190 can receive a power-on command. The processor 190 can obtain whether a power-on command has been received S101.

When the processor 190 receives the power-on command, the processor 190 can determine whether the compression ratio (or RSSI) is included in the first critical interval S103.

According to one embodiment, when the processor 190 receives the power-on command, the processor 190 can determine whether the compression ratio is included in the first critical interval. Here, the first critical interval may be 15:1 to 30:1, but this is only an example and it is reasonable that it is not limited thereto.

According to another embodiment, when the processor 190 receives the power-on command, the processor 190 can determine whether the RSSI is included in the first critical interval. Here, the RSSI is only an example of a wireless signal performance. That is, when the processor 190 receives the power-on command, the processor 190 can determine whether the performance of a wireless signal other than the RSSI is included in the first critical interval. Hereinafter, for the convenience of explanation, the embodiment of FIG. 15 is described based on the compression ratio, but instead of the compression ratio, the processor 190 may operate based on the performance of a wireless signal such as RSSI.

The processor 190 may display a message asking whether to execute the operation in the antenna auto-adjustment mode if the compression ratio (or RSSI) is included in the first critical interval S105.

The method of displaying the message asking whether to execute the operation in the antenna auto-adjustment mode is the same as the description in FIG. 11, so the duplicate description is omitted.

The processor 190 may determine whether an execution command for the antenna auto-adjustment mode has been received after displaying the message asking whether to execute in the antenna auto-adjustment mode S107.

The processor 190 can receive the execution command of the antenna auto-adjustment mode through a remote control device 300, etc.

When the processor 190 receives the execution command of the antenna auto-adjustment mode, the processor 190 can execute the antenna auto-adjustment mode S109.

The execution method of the antenna auto-adjustment mode is the same as the description of FIG. 12, so duplicate descriptions are omitted.

After executing the antenna auto-adjustment mode, the processor 190 can determine whether the compression ratio (or RSSI) is included in the second or third critical interval S111.

The second critical interval is an interval in which the compression ratio is lower than the first critical interval. In other words, the antenna sensitivity when the compression ratio is included in the second critical interval is higher than the antenna sensitivity when the compression ratio is included in the first critical interval. For example, the second critical interval can be 8:1 to 15:1, but this is only an example and should not be limited thereto.

The third critical interval is an interval in which the compression ratio is lower than the compression ratio of the second critical interval. That is, the antenna sensitivity when the compression ratio is included in the third critical interval is higher than the antenna sensitivity when the compression ratio is included in the second critical interval. For example, the third critical interval can be an interval less than or equal to 8:1, but this is only an example and should not be limited thereto.

If the processor 190 executes the antenna auto-adjustment mode and the compression ratio (or RSSI) is not included in the second or third critical interval, the processor 190 can execute the antenna auto-adjustment mode again.

The processor 190 may terminate the operation if the compression ratio (or RSSI) is included in the second or third critical interval after executing the antenna auto-adjustment mode.

Meanwhile, the processor 190 may determine whether the compression ratio (or RSSI) is included in the second critical interval if the compression ratio (or RSSI) is not included in the first critical interval upon receiving the power-on command S113.

The processor 190 may terminate the operation if the compression ratio (or RSSI) is not included in the second critical interval. The fact that the compression ratio (or RSSI) is not included in both the first and second critical intervals means that the signal quality is excellent, and therefore, there is no need to perform the antenna auto-adjustment or the antenna beam adjustment described below:

The processor 190 may execute the antenna beam adjustment mode if the compression ratio (or RSSI) is included in the second critical interval S115.

The second critical interval indicates an intermediate antenna sensitivity. Therefore, in this case, the antenna beam adjustment mode can be executed to improve the compression ratio by adjusting the angle of the beam through beam forming within a range of 90 degrees without rotating the antenna.

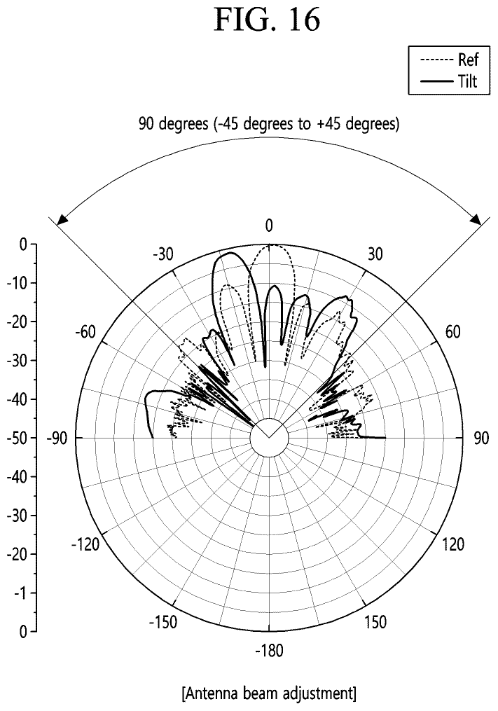

FIG. 16 is a diagram for explaining a method in which a wireless transmission device according to an embodiment of the present disclosure operates in an antenna beam adjustment mode.

The antenna beam adjustment mode may be an operation mode that finds the angle of the beam with the greatest signal strength within a 90-degree range (from −45° to +45° based on the antenna direction) through beam forming while the antenna angle is fixed, and adjusts the angle of the beam to the corresponding angle.

The processor 190 may terminate the operation after executing the antenna beam adjustment mode.

Next, FIG. 17 is a flowchart illustrating a method for adjusting an antenna when a wireless transmission device according to an embodiment of the present disclosure receives a power-off command.

The processor 190 may receive the power-off command. The processor 190 may obtain whether the power-off command has been received S201.

When the processor 190 receives the power-off command, the processor 190 may determine whether the compression ratio (or RSSI) is included in the first or second critical interval S203.

The first to third critical intervals are as described in FIG. 15.

The processor 190 can control the display as a black screen if the compression ratio (or RSSI) is included in the first or second critical interval (S205).

The processor 190 can control the display 260 to display a black screen so that it looks like a power-off state while operating in the antenna auto-adjustment mode if the compression ratio (or RSSI) is included in the first or second critical interval, since the signal quality is poor and the antenna auto-adjustment mode is required.

The processor 190 can execute the antenna auto-adjustment mode after controlling the display as the black screen S207.

The method of executing the antenna auto-adjustment mode is the same as the description of FIG. 12, so the duplicate description is omitted.

The processor 190 can determine whether the compression ratio (or RSSI) is included in the second or third critical interval after executing the antenna auto-adjustment mode S209.

The processor 190 can turn off the power if the compression ratio (or RSSI) is included in the second or third critical interval S211. The processor 190 can terminate the operation after turning the power off.

Meanwhile, the first embodiment illustrated in FIG. 10 and the second embodiment illustrated in FIGS. 15 to 17 may be executed separately. However, the first and second embodiments described above are compatible embodiments, and both the first and second embodiments may be applied to a single wireless transmission device.

According to one embodiment of the present disclosure, the above-described method can be implemented as a processor-readable code on a medium in which a program is recorded. Examples of the processor-readable medium include ROM, RAM, CD-ROM, magnetic tape, floppy disk, optical data storage device, etc.

The wireless transmission device and the wireless display system described above is not limited to the configuration and method of the embodiments described above, and the embodiments may be configured by selectively combining all or part of each embodiment so that various modifications can be made.

What is claimed is:

1. A wireless transmission device, comprising:
a compression chip configured to compresses at least one of a video signal and an audio signal;
at least one antenna configured to transmit a wireless signal compressed by the compression chip; and
a processor configured to control the antenna,
wherein the processor is configured to perform an antenna auto-adjustment mode that automatically adjusts an angle of the antenna.

2. The wireless transmission device of claim 1, wherein the processor is configured to:
search for a strong electric field sector while changing the angle of the antenna by a first angle unit, and determine the angle of the antenna based on a signal strength measured while changing the angle of the antenna by a second angle unit smaller than the first angle within the searched strong electric field sector, when performing the antenna auto-adjustment mode.

3. The wireless transmission device of claim 2, wherein the processor is configured to:
determine an up-down angle and a left-right angle of the antenna by searching the strong electric field sector for each of up-down direction and left-right direction and then determining direction of the antenna within the searched strong electric field sector.

4. The wireless transmission device of claim 1, wherein the processor is configured to:
operate by selecting one detailed operation mode among a precision mode, a general mode, and a fast mode when performing the antenna auto-adjustment mode.

5. The wireless transmission device of claim 4, wherein the processor is configured to:
determine an antenna angle by searching for a strong electric field sector while changing by a first angle unit within all antenna angle ranges, and then changing by a second angle unit smaller than the first angle within the searched strong electric field sector in the precision mode,
determine the antenna angle by scanning all adjustable antenna angle ranges in the general mode, and
determine the antenna angle by adjusting the antenna by a predetermined angle based on the current antenna angle in the fast mode.

6. The wireless transmission device of claim 1, wherein the processor is configured to:
operate in the antenna auto-adjustment mode when a power of the wireless transmission device is switched from on to off.

7. The wireless transmission device of claim 1, wherein the processor is configured to:
operate in the antenna auto-tuning mode when a change in position of the wireless transmission device is detected.

8. The wireless transmission device of claim 1, wherein the processor is configured to:
control a wireless reception device so that to display a message asking whether to execute operation in the antenna auto-adjustment mode when a signal strength of the wireless signal is below a preset threshold.

9. The wireless transmission device of claim 1, further comprising:
an up-down adjustment motor for adjusting an angle of the antenna in vertical direction; and
a left-right adjustment motor for adjusting the angle of the antenna in left-right direction.

10. The wireless transmission device of claim 9, further comprising:
a case in which the compression chip, the antenna, and the processor are accommodated inside; and
a plate which is placed on an upper surface of the case, and the antenna is connected at a lower portion, and is rotatable,
the up-down adjustment motor adjusts an up-down angle of the antenna, and
the left-right adjustment motor is installed on the lower portion of the plate and rotates the plate to adjust the left-right angle of the antenna.

11. A wireless display system including a wireless transmission device and a wireless reception device, wherein the wireless transmission device comprising:
a compression chip configured to compresses at least one of a video signal and an audio signal;
at least one antenna configured to transmit a wireless signal compressed by the compression chip; and
a processor configured to control the antenna,
wherein the processor is configured to perform an antenna auto-adjustment mode that automatically adjusts an angle of the antenna.

12. The wireless display system of claim 11, wherein the processor is configured to:
search for a strong electric field sector while changing the angle of the antenna by a first angle unit, and determine the angle of the antenna based on a signal strength measured while changing the angle of the antenna by a second angle unit smaller than the first angle within the searched strong electric field sector, when performing the antenna auto-adjustment mode.

13. The wireless display system of claim 12, wherein the processor is configured to:
determine an up-down angle and a left-right angle of the antenna by searching the strong electric field sector for each of up-down direction and left-right direction and then determining direction of the antenna within the searched strong electric field sector.

14. The wireless display system of claim 11, wherein the processor is configured to:
operate by selecting one detailed operation mode among a precision mode, a general mode, and a fast mode when performing the antenna auto-adjustment mode, determine an antenna angle by searching for a strong electric field sector while changing by a first angle unit within all antenna angle ranges, and then changing by a second angle unit smaller than the first angle within the searched strong electric field sector in the precision mode,
determine the antenna angle by scanning all adjustable antenna angle ranges in the general mode, and
determine the antenna angle by adjusting the antenna by a predetermined angle based on the current antenna angle in the fast mode.

15. The wireless display system of claim 11, further comprising:
an up-down adjustment motor for adjusting an angle of the antenna in vertical direction;
a left-right adjustment motor for adjusting the angle of the antenna in left-right direction;
a case in which the compression chip, the antenna, and the processor are accommodated inside; and
a plate which is placed on an upper surface of the case, and the antenna is connected at a lower portion, and is rotatable,
the up-down adjustment motor adjusts an up-down angle of the antenna, and
the left-right adjustment motor is installed on the lower portion of the plate and rotates the plate to adjust the left-right angle of the antenna.
